(19) United States
(12) Patent Application Publication
(10) Pub. No.: US 2022/0343152 A1
(43) Pub. Date: Oct. 27, 2022

(54) ENERGY BASED PROCESSES FOR EXCHANGEABLE DATA

(71) Applicant: Google LLC, Mountain View, CA (US)

(72) Inventors: Bo Dai, San Jose, CA (US); Mengjiao Yang, Mountain View, CA (US); Hanjun Dai, Atlanta, GA (US); Dale Eric Schuurmans, Mountain View, CA (US)

(21) Appl. No.: 17/239,320

(22) Filed: Apr. 23, 2021

(51) Int. Cl. G06N 3/08; G06N 3/04

(52) U.S. Cl. CPC G06N 3/08; G06N 3/0454; G06N 3/0472; G06N 3/0445

(57) ABSTRACT

Methods, systems, and apparatus, including computer programs encoded on a computer storage medium, for generative modelling of an exchangeable sets. Methods can include obtaining a dataset of training observations. Each training observation is an exchangeable set that includes a plurality of data points. Each training observations is processed using a first neural network to generate parameters of a first probability distribution based on which a latent variable is sampled. The latent variable is processed using a second neural network to generate a new observation that includes a plurality of data points. The training observation and the new observation is processed using an energy neural network to generate an estimate of an energy of the training observation and the new observation. The energy neural network is then trained to optimize an objective function that measures the difference between the estimate of the energy of the training observation and the new observation.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

In general, one innovative aspect of the subject matter described in this specification can be embodied in methods including the operations of obtaining a dataset including a plurality of training observations, wherein each training observation is an exchangeable set, the exchangeable set including a plurality of data points; for each training observation: processing, using a first neural network, the data points of the training observation to generate parameters of a first probability distribution; sampling, from the first probability distribution, a latent variable based on the first probability distribution; processing the latent variable using a second neural network to generate a new observation including a plurality of data points; and processing the training observation and the new observation using an energy neural network to generate an estimate of an energy of the training observation and an estimate of an energy of the new observation; and training the energy neural network to optimize an objective function that measures the difference between the estimate of the energy of the training observation and the estimate of the energy of the new observation.

Other embodiments of this aspect include corresponding methods, apparatus, and computer programs, configured to perform the actions of the methods, encoded on computer storage devices. These and other embodiments can each optionally include one or more of the following features.

Methods can include training the first neural network to model the data points of the training observation as a stochastic process; and training the energy neural network to optimize the objective function that minimizes the difference between the distribution of the training observations and the new observations.

Methods can include the objective function of the energy neural network that is of the form

$$\begin{matrix}max \\ {{w}^{′} , q}_{} ( {θ \vert x}_{1 : n} )\end{matrix} \begin{matrix}min \\ {}_{q} ( {x}_{1 : n} , v \text{\textbar θ} )\end{matrix} \begin{matrix}L ( q ( {\text{θ\textbar} x}_{1 : n} ) , q ( {x}_{1 : n} , v \text{\textbar θ} ) ; {w}^{′} ) \\ \end{matrix}$$

$$wherein$$

$$L ( q ( {\text{θ\textbar} x}_{1 : n} ) , q ( {x}_{1 : n} , v \text{\textbar θ} ) ; {w}^{′} ) := {\hat{𝔼}}_{{x}_{1 : n}} {𝔼}_{q} ( {\text{θ\textbar} x}_{1 : n} ) [ {f}_{{w}^{′}} ( {x}_{1 : n} ; θ ) ] - {\hat{𝔼}}_{{x}_{1 : n}} {𝔼}_{q} ( {\text{θ\textbar} x}_{1 : n} ) [ {𝔼}_{q} ( {x}_{1 : n} , v \text{\textbar θ} ) [ {f}_{{w}^{′}} ( {x}_{1 : n} ; θ ) - \frac{λ}{2} {v}^{T} v ] ] - {\hat{𝔼}}_{{x}_{1 : n}} [ H ( q ( {x}_{1 : n} , v \text{\textbar θ} ) ) - KL ( q ( {\text{θ\textbar} x}_{1 : n} ) \vert \vert p ( θ ) ) ]$$

and wherein x_{1:n} are the training data points, θ is the latent variable, q is the first probability distribution, v is a auxiliary momentum variable and H is a Hamiltonian dynamic embeddings.

Methods can include modelling the first probability distribution as a distribution that belongs to an exponential family of distributions. Methods can also include each training observation of the dataset to include a plurality of unordered data points.

Methods can include the training observation to be a set of points from a point cloud.

Methods can include such that the second neural network is a recurrent neural network that generates the data points in the new observation over a plurality of time steps. Methods can also include wherein the first neural network is a convolutional neural network.

Particular embodiments of the subject matter described in this specification can be implemented so as to realize one or more of the following advantages. Some approaches exist for modeling sets with exchangeability, e.g., point clouds. However, existing approaches restrict the cardinality of the sets considered or can only express limited forms of distribution over unobserved data. This prevents these existing approaches from being used in real-world tasks. To overcome these limitations, the described Energy-Based Processes (EBPs) techniques extend energy based models to exchangeable data while allowing neural network parameterizations of the energy function. A key advantage of these models is the ability to express more flexible distributions over sets without restricting their cardinality. The specification also describes an efficient training procedure for EBPs that results in trained models that demonstrate state-of-the-art performance on a variety of tasks that require modeling exchangeable data, e.g., point cloud generation, classification, denoising, and image completion. As a particular example, the techniques discussed throughout this document can be used to process raw data from sensors such as LiDAR, depth cameras or any 3D sensor that suffers from incomplete data due to interference or occlusion in the physical world, to generate the missing parts for the data.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system of machine learning models.

FIG. 2 is a flowchart of an example process of modelling an exchangeable set using the generative modelling system.

FIG. 3 is a flowchart of an example training process of the generative modelling system.

FIG. 4 is a flowchart of an example process of inferring from the generative modelling system.

Like reference numbers and designations in the various drawings indicate like element.

### DETAILED DESCRIPTION

This document discloses methods, systems, apparatus, and computer readable media on one or more computers in one or more locations that performs generative modelling of exchangeable sets. An exchangeable set can be defined as an observation (also referred to as an exchangeable observation) that includes multiple unordered data points. An exchangeable observation can be represented as xᵢ={x₁, . . . xₙ} where an observation xᵢ includes n unordered data points.

Such exchangeable sets can be obtained as observations from sensors such as LiDAR, depth cameras or any 3D sensor. For example, a point cloud of an object observed by a LiDAR can include multiple unordered data points where each data point is an X, Y and Z co-ordinate based on the relative positions of the object and the LiDAR w.r.t., the 3D coordinate system defined by the LiDAR. As for another example, an image can include multiple pixels as data points where each pixel position can include an x-coordinate, y-coordinate and one or more channel values of the pixels.

In some implementations, the methods and techniques described in this document can be implemented in an environment that requires an automatic implementation for generating new observations that plausibly come from an existing distribution of observations. For example, the described techniques can be used to generate new images that are similar but specifically different from a dataset of existing images. In another example, the current invention can be used for modelling point clouds. For example, in many situations raw point clouds generated by 3D scanning devices and depth cameras are usually sparse, noisy and suffer from missing data due to limited angles of view or occlusion. In such situations, the sparse, noisy and incomplete raw point cloud observations can be processed using the described methods and techniques to generate new data points for the observations that enhance the utility of the point clouds.

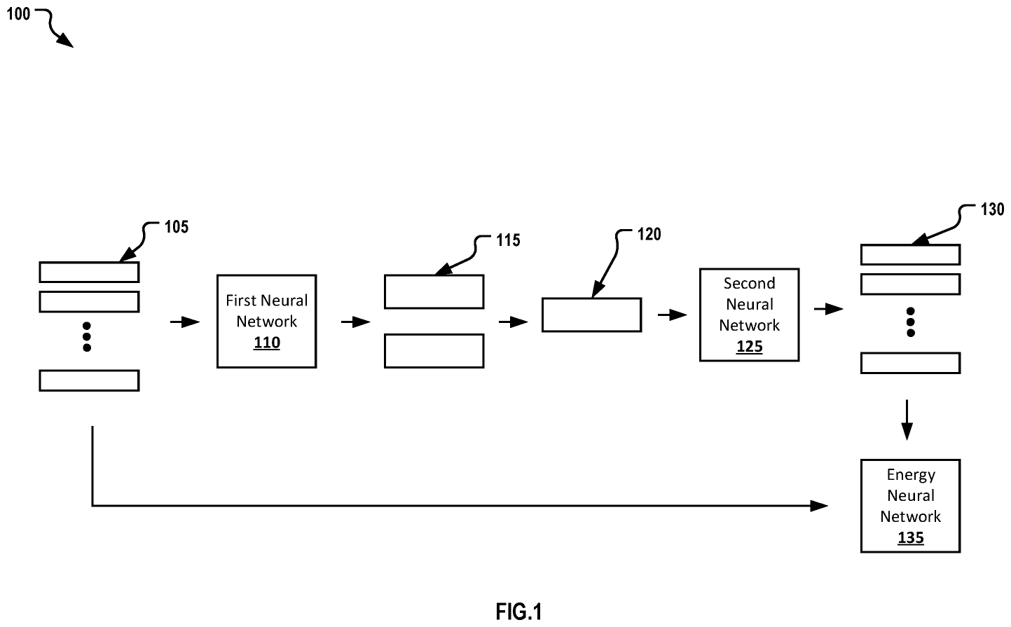

FIG. 1 shows a block diagram of an example generative modeling system 100 that can be used to learn the true distribution of a training dataset D of exchangeable sets and, after, training can be used to generate new data points with some variation in both supervised and unsupervised settings.

The generative modelling system 100 is a system implemented as one or more computer programs in one or more physical locations and includes a first neural network 110, a second neural network 125 and an energy neural network 135 that are trained using a training dataset D that includes multiple exchangeable observations (also referred to as training observation) where each training observation can include n unordered data points that can vary based on the training observations.

In some implementations, the first neural network 110 of the generative modelling system 100 can be configured to generate parameters 115 of a probability distribution (referred to as a first probability distribution) according to the training observations from the training dataset D. For example, the first neural network 110 can be a neural network that includes multiple convolution layers (e.g., 1D convolution layer) with interleaved non-linear activation and max-pooling layers with multiple trainable parameters (α). The first neural network 110 configured to receive as input, a training observation xᵢ={x₁, . . . xₙ} from the training dataset D and process the training observation xᵢ that includes multiple data points xᵢ, . . . xₙto model the probability distribution of the training dataset D as the first probability distribution and generate parameters 115 that define the first probability distribution. For example, the first neural network 110 can model the first probability distribution 115 of the dataset D as a Gaussian distribution parameterized by parameters 115 that includes mean μ and standard deviation σ. In this example, the first neural network 110 can process a training observation to output the mean μ and, optionally, the standard deviation σ of the Gaussian distribution.

In some implementations, after generating the parameters 115 of the first probability distribution, the generative modelling system 100 can sample a latent variable θ 120 based on the parameters 115 using neural network reparameterization that allows sampling the latent variable θ from the first probability distribution to be independent of the parameters of the first probability distribution. The first probability distribution from which the latent variable θ is sampled can be conditioned on the multiple data points of the training observations 105 that was provided as input to the first neural network 110. This can be represented as follows

ti θ˜q(x_{1:n})

In some implementations, the second neural network 125 of the generative modelling system 100 can be configured to receive as input, the latent variable θ 120 and the training observations xᵢ={x₁, . . . xₙ} to process and model a distribution (referred to as a second probability distribution) of the training observation xᵢ={x₁, . . . xₙ} conditioned over the latent variable θ 120. The second probability distribution can be represented as q(x_{1:n},v|θ) where v is an auxiliary momentum variable. The auxiliary momentum variable v is described in more detail in Neal, Radford M. “MCMC using Hamiltonian dynamics.” Handbook of markov chain monte carlo 2.11 (2011): 2. the entire content of which is hereby incorporated by reference herein in its entirety.

The generative modelling system 100 can then sample multiple data points from the second probability distribution to generate a new observation 130 corresponding to the training observation that was provided as input to the first neural network 110. For example, the second neural network 125 can receive as input, a training observation x={x₁, . . . xₙ} and a latent variable θ 120 that was generated by sampling from the first probability distribution based on the training observation, and generate as output, multiple data points of a new observation \hat{x}_{1:n}˜q(x_{1:n},v|θ).

For example, the second neural network 125 can be a recurrent neural network (RNN) that can include multiple recurrent long short-term memory (LSTM) blocks with multiple trainable parameters (β). Each LSTM blocks can further include multiple neural network layers with interleaved non-linear activation. Other alternatives of RNN can include normalizing flows that describes the transformation of a probability density through a sequence of invertible mappings. For example, the second neural network 125 can be a RNN with four LSTM blocks that can include a multi-layer perceptron (MLP) with 64, 128 and 512 hidden neurons with interleaved ReLU. Each LSTM block can generate 512 data points autoregressively generating a total of 2048 data points such that each set of 512 data points can be generated based on the prior set of 512 data points and the latent variable θ.

In some implementation, to sample the data points of the new observation 130, the generative modelling system 100 can use Langevin dynamics to further fine tune the data points of the new observation 130. As another example, if the new observation 130 is an image, the RNN can include one LSTM block that generates n number of data points and n is the number of pixels of the image.

In some implementations, the energy neural network 135 of the generative modelling system 100 can be configured to receive and process the training observations 105 from the dataset D and the corresponding new observations 130 generated by the second neural network 125 to determine the similarity between the observations. For example, the energy neural network 135 can determine the similarity by comparing the energy of the data points of the training observations 105 from the dataset D and the corresponding new observations 130.

To determine the similarity, the generative modelling system 100 can use the energy neural network 135 to model the training observation 105 as a stochastic process that can be constructed using Kolmogrov extension. In such implementations, the latent variable θ 120 can be generated using a latent variable model that can be represented as

θ˜p(θ),xₜ_{ᵢ}˜p(x|θ,tᵢ),∀i∈{1, . . . ,n}∀n 1

The generative modelling system 100 can model the distribution of the data points x of the training observation 105 i.e. p_{w}(x|θ,tᵢ) in equation 1 using an energy function ƒ_{w} with learnable parameters w as follows

$${p}_{w} ( x \text{\textbar θ} , t ) = \frac{exp ( {f}_{w} ( x , t ; θ ) )}{Z ( {f}_{w} , t ; θ )} \\ where Z ( {f}_{w} , t ; θ ) = \int exp ( {f}_{w} ( x , t ; θ ) ) dx \qquad 2$$

In some implementations, the energy neural network 135 can also approximate the first probability distribution p_{w} of the data points of the training observation using an alternative probability distribution p_{w′} where ƒ_{w′} is the energy function learned using the parameters w′ of the energy neural network 135.

The energy neural network 135 can receive as input, a training observation 105 that was provided to the first neural network 110 and the new observation 130 that was generated by the second neural network 135 to process and determine the similarity between the two observations using the following objective function.

$$\begin{matrix}max \\ {{w}^{′} , q}_{} ( {θ \vert x}_{1 : n} )\end{matrix} \begin{matrix}min \\ {}_{q} ( {x}_{1 : n} , v \text{\textbar θ} )\end{matrix} \begin{matrix}L ( q ( {\text{θ\textbar} x}_{1 : n} ) , q ( {x}_{1 : n} , v \text{\textbar θ} ) ; {w}^{′} ) \\ \end{matrix} \qquad 3$$

$$wherein$$

$$L ( q ( {\text{θ\textbar} x}_{1 : n} ) , q ( {x}_{1 : n} , v \text{\textbar θ} ) ; {w}^{′} ) := {\hat{𝔼}}_{{x}_{1 : n}} {𝔼}_{q} ( {\text{θ\textbar} x}_{1 : n} ) [ {f}_{{w}^{′}} ( {x}_{1 : n} ; θ ) ] - {\hat{𝔼}}_{{x}_{1 : n}} {𝔼}_{q} ( {\text{θ\textbar} x}_{1 : n} ) [ {𝔼}_{q} ( {x}_{1 : n} , v \text{\textbar θ} ) [ {f}_{{w}^{′}} ( {x}_{1 : n} ; θ ) - \frac{λ}{2} {v}^{T} v ] ] - {\hat{𝔼}}_{{x}_{1 : n}} [ H ( q ( {x}_{1 : n} , v \text{\textbar θ} ) ) - KL ( q ( {\text{θ\textbar} x}_{1 : n} ) \vert \vert p ( θ ) ) ]$$

and where H(q(x_{1:n},v|θ)) is a learnable Hamiltonian/Langevin sampler, q(x_{1:n}) is the first probability distribution learned by adjusting the parameters of the first neural network, q(x_{1:n},v|θ) is the second neural network learned by adjusting the parameters of the second neural network and ƒ_{w′} is the energy function learned using the parameters w′ of the energy neural network.

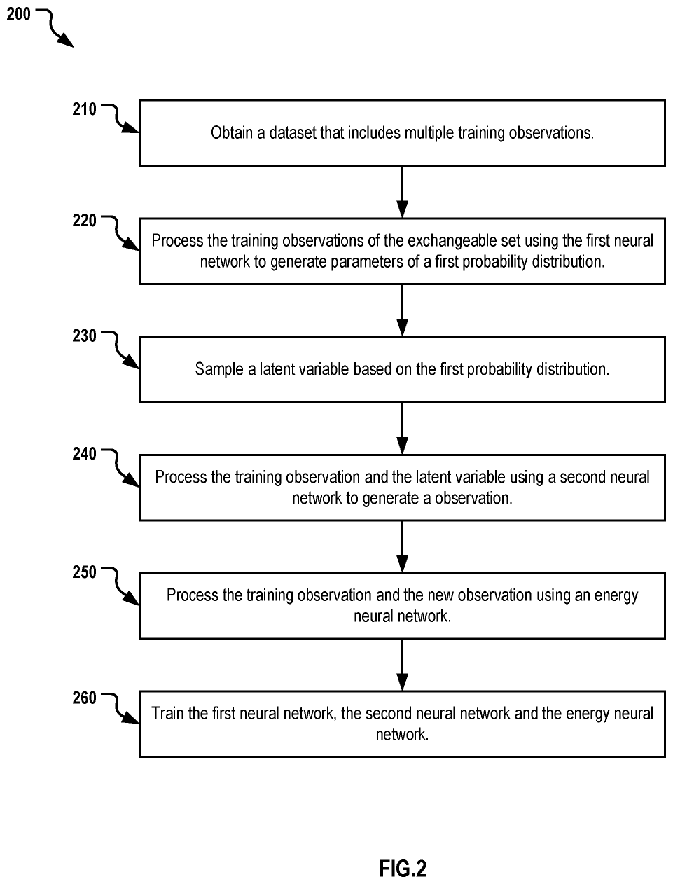

FIG. 2 is a flowchart of an example process 200 of modelling an exchangeable set using the generative modelling system 100. The process 200 is implemented in a computer system that includes one or more computers.

The generative modelling system 100 obtains a dataset D that includes multiple observations of exchangeable sets (210). As mentioned before, a dataset D can include multiple training observations where each observation is an exchangeable set that can include multiple unordered data points. Such a dataset can be obtained from sensors such as LiDAR, depth cameras or any 3D sensor. For example, a dataset D can include multiple training observations where each observation is a point cloud of an object observed by a LiDAR that can include multiple unordered data points where each data point is an X, Y and Z co-ordinate based on the relative positions of the object and the LiDAR w.r.t., the 3D co-ordinate system defined by the LiDAR. As for another example, a dataset D can include multiple observations where each observation is an image that can include multiple data points where each data point can correspond to a pixel of the image.

The first neural network 110 of the generative modelling system 100 processes the training observations to generate parameters of a first probability distribution (220). For example, the first neural network 110 is configured to receive as input training observations 105 from the dataset D and model the probability distribution of the dataset D as the first probability distribution and generate parameters 115 that define the first probability distribution. For example, the first neural network 110 can model the first probability distribution 115 of the dataset D as a Gaussian distribution parameterized by parameters 115 that includes mean μ and standard deviation σ.

The generative modelling system 100 samples a latent variable from the first probability distribution (230). For example, the generative modelling system 100 can sample a latent variable θ 120 based on the parameters 115 using neural network reparameterization that allows sampling the latent variable θ from the first probability distribution to be independent of the parameters of the first probability distribution that can be represented as θ˜q(x_{1:n}).

The second neural network 125 processes the training observation and the corresponding latent variable to generate a new observation (240). For example, the second neural network 125 can receive as input, a training observation 105 and a corresponding latent variable θ 120 that was generated by sampling from the first probability distribution based on the training observation, and generate as output, multiple data points of a new observation 105 that can be represented as \hat{x}_{1:n}˜q(x_{1:n},v|θ).

The generative modelling system 100 determines the similarity between the training observation 105 and the new observation 130 using an energy neural network 135 (250). For example, the energy neural network 135 of the generative modelling system 100 can be configured to receive and process the training observations 105 from the dataset D and the corresponding new observations 130 generated by the second neural network 125 to determine the similarity between the observations using an energy function f learned using the parameters w′ of the energy neural network 135.

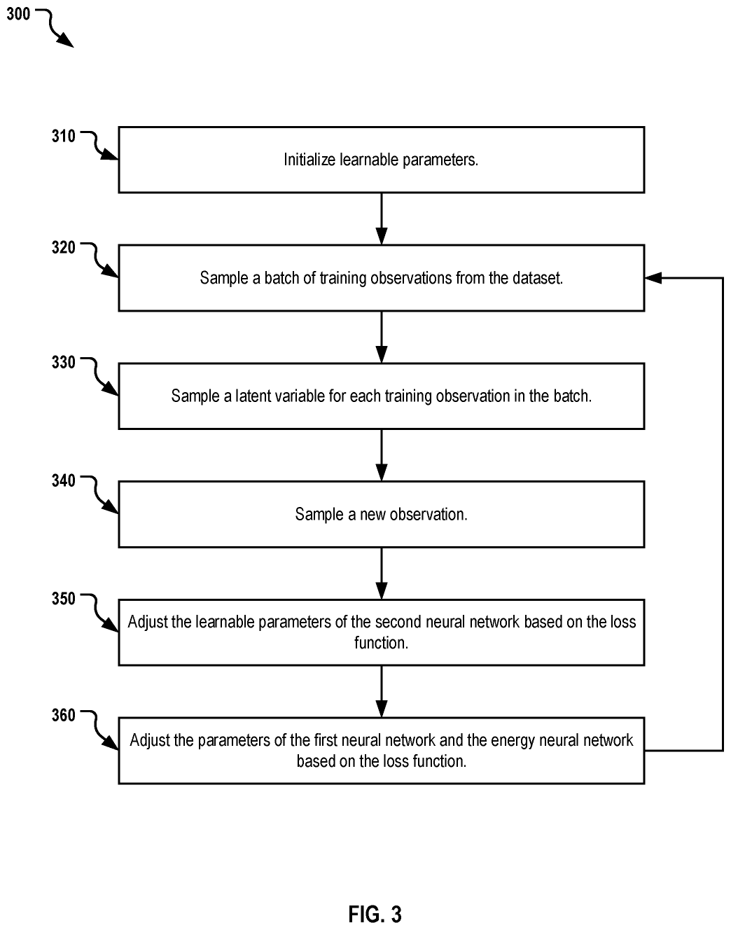

The generative modelling system 100 trains the first neural network 110, the second neural network 125 and the energy neural network 135 (260). For example, the first neural network 110, the second neural network 125 and the energy neural network 135 can be trained jointly using a loss function defined as equation 3. During the training process the parameters of the first neural network 110, the second neural network 125 and the energy neural network 135 are adjusted so as to minimize the difference between the training observations 105 and new observation 130. The details of the training process is further explained with reference to FIG. 3.

FIG. 3 is a flowchart of an example training process 300 of the generative modelling system 100. The training process 300 of the generative modelling system 100 is an iterative process to adjust the learnable parameters of the first neural network 110, the second neural network 125 and the energy neural network 135. During each iteration of the training process 300, a batch of training observations is provided as input to the first neural network 110. For each observation in the batch, the first neural network 125 models the dataset D as a first probability distribution of a latent variable 120 conditioned over the training observation. The generative modelling system 100 then samples a latent variable from the first probability distribution and provides the latent variable and the corresponding training observation to the second neural network 125. The second neural network 125 processes the latent variables and models the training observations as a second probability distribution conditioned over the latent variable from where multiple data points of a new observation is sampled. The energy neural network 135 then uses the loss function L (defined in equation 3) to compare the training observation 105 and the new observation 130. During each iteration of the training process 300 and based on the similarity of the training observation 105 and the new observation 130, the learnable parameters of the first neural network 110, the second neural network 125 and the energy neural network 135 are adjusted. The training process 300 is implemented in a computer system that includes one or more computers.

The learnable parameters of the generative modelling system 100 are initialized (310). As mentioned previously, the generative modelling system 100 includes (i) the first neural network 110, (ii) the second neural network 125, and (iii) the energy neural network 135. Each of the three neural networks includes learnable parameters that can be initialized using any appropriate parameter initialization scheme, e.g., using the Glorot uniform initializer. The parameters can be adjusted during the training process.

A batch of training observations 105 is sampled from the dataset D (320). For example, during training, batches of training observations from the dataset D that includes one or more observations are provided as input to the generative modelling system 100. If the dataset D includes m training observations and each batch includes j samples, then in each of the k=m/j training iterations, a batch of training observations is sampled and provided as input to the first neural network 110 of the generative modelling system 100.

A latent variable is sampled for each training observation in a batch (330). During the training process, batches of training observations are iteratively provided as input to the first neural network 110 of the generative modelling system 100. Assuming that there are j training observations in each batch, during each iteration of the training process 300, the first neural network 110 processes j training observations that each includes multiple data points. For each training observation 105, the first neural network 110 processes the multiple data points of the training observation 105 and models the probability distribution of the dataset D as the first probability distribution and generates parameters 115 that define the first probability distribution. For example, the first neural network 110 can process and model the first probability distribution as a Gaussian distribution for each of the j training observation and generates j set of parameters 115 where each set can include mean μ and, optionally, variance a that define the corresponding first probability distribution.

The generative modelling system 100 then samples a latent variable 120 based on the parameters 115 of the first probability distribution. For example, based on the j sets of parameters 115 defining j first probability distributions for each of the j training observations in a batch, the generative modelling system 100 samples j latent variables 120.

A new observation 130 is sampled using the second neural network (340). After sampling j latent variables 120 for each of the j training observations, the j latent variables and the corresponding training observations are provided as input to the second neural network 125. The second neural network 125 processes each latent variable 120 and the corresponding training observation 105 to generate data points of a new observation 130 by modelling the second probability distribution of the training observation conditioned over the latent variables 120.

The parameters of the second neural network 125 are adjusted based on the loss function (350). The third neural network 135 compares the j training observation 105 and the corresponding new observations 130 to compute an overall loss value that can be computed using the loss function L (defined as equation 3). The generative modelling system 100 then computes an overall loss based on the j loss values and updates the learnable parameters of the second neural network 125 by adjusting the parameters using back propagation. For example, during each iteration, the energy neural network 135 performs j comparisons between the training observations 105 and the corresponding new observations 130 to calculate j loss values. The generative modelling system 100 can then calculate an overall loss that is the average of the j loss values and updates the learnable parameters of the second neural network based on the parameter values of the prior iteration and the overall loss. For example, the learnable parameters (β) of the second neural network 125 can be adjusted based on the following equation

{βₖ₊₁}=βₖ−γₖ∇_{β}L 4

where k is the current iteration of the training process 300 and γₖ is the learning rate

The parameters of the first neural network 110 and the energy neural network 135 are adjusted based on the loss function (360). Similar to the step 250 of the training process 300, the generative modelling system 100 then computes an overall loss based on the j loss values and updates the learnable parameters of the first neural network 110 and the energy neural network 135 by adjusting the parameters using back propagation. For example, the learnable parameters (α) of the first neural network 110 and the learnable parameters (w′) energy neural network 135 can be adjusted based on the following equation 5

{α,w′}ₖ₊₁={α,w′}ₖ+γₖ∇_{{α,w′}}L

In some implementations, the training process 300 can iterate until all batches of training observations 105 have been provided as input to the first neural network 110. For example, if the dataset D includes m observations and each batch includes j training examples, then the training process 300 can include k=m/j training iterations. In another implementation, the training process 300 can iterate until the overall loss value according to the loss function L is below a predetermined threshold. The predetermined threshold can be set by the system designer.

In some implementations, after training the generative modelling system 100, the system 100 can be used to infer new data points within a particular observation. For example, the generative modelling system 100 can be used for image completion. In such an implementation, the generative modelling system 100 is trained on a dataset D that includes multiple images. During inference, the generative modelling system 100 can receive as input, an incomplete image (i.e., an image with one or more missing pixel values), process the image data using the first neural network 110 and the second neural network 125 to generate a new complete image based on the distribution of images of the dataset D on which the generative modelling system 100 was trained.

In another example, the generative modelling system 100 can be used to model point clouds. In such an implementation, the generative modelling system 100 is trained on a dataset D that includes point clouds obtained from a 3D sensor. During inference, the generative modelling system 100 can receive as input an incomplete point cloud (i.e., a point cloud with one or more missing 3D coordinates), process the point cloud data using the first neural network 110 and the second neural network 125 to generate a new point cloud based on the distribution of point clouds of the dataset D on which the generative modelling system 100 was trained. For example, self-driving cars using LiDAR to collect information about the surrounding can collect incomplete point clouds of objects in its surroundings (for e.g., vehicles on the road obstructed by another vehicle). In such a situation, the incomplete point cloud of objects can be provided as input to the generative modelling system 100 to generate a new complete point cloud that can assist in identifying the objects.

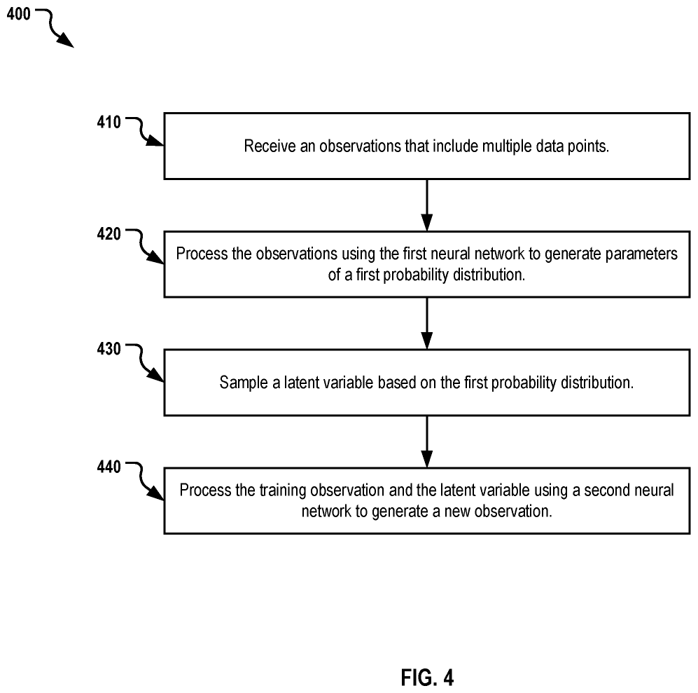

FIG. 4 is a flowchart of an example inference process 400 of the generative modelling system 100. The process 400 assumes that the generative modelling system 100 is trained using the training process 400. During inference, an observation that includes multiple data points is provided as input to the first neural network 110. The first neural network 125 processes the observation based on the learned parameters α that models the observation as first probability distribution. The generative modelling system 100 then samples a latent variable θ 120 from the first probability distribution and provides the latent variable and the corresponding observation to the second neural network 125. The second neural network 125 processes the latent variables and observation using the learned parameters β to generate multiple data points of a new observation. To further explain the process 400, assume that the generative modelling system 100 is implemented for point cloud completion. In such an example, the generative modelling system 100 is trained using a dataset D that includes multiple observations where each observation is a point cloud that includes multiple data points corresponding to the X, Y and Z coordinates. In this example, the generative modelling system 100 and in particular the second neural network 125 is configured to generate 2048 data points of the new observation generated using the second neural network 125. The inference process 400 is implemented in a computer system that includes one or more computers.

The generative modelling system 100 receives an observation (410). For example, a point cloud observation can be obtained from 3D sensors such as LiDAR, depth cameras. The observation can include multiple data points. In this example, the observation includes less than 2048 data points. For example, a self-driving vehicle using LiDAR to collect information about the surrounding vehicles can collect incomplete point clouds of other vehicles in its surroundings due to an obstructed view of the other vehicles. In such a situation, the incomplete point cloud of vehicles can be provided as input to the generative modelling system 100 to generate a new complete point cloud that can assist in identifying the vehicles.

The first neural network 110 of the generative modelling system 100 processes the observations to generate parameters of a first probability distribution (420). For example, the first neural network 110 is configured to receive as input, the point cloud observation collected from a LiDAR and process the point cloud observation using the learned parameters α of the first neural network 110 to generate parameters 115 that define the first probability distribution. For example, if the first probability distribution is a Gaussian distribution learned during training process, the parameters 115 can includes mean μ and standard deviation σ.

The generative modelling system 100 samples a latent variable (430). For example, the generative modelling system 100 can sample a latent variable θ 120 based on the parameters 115.

The second neural network 125 of the generative modelling system 100 processes the observation and the latent variable to generate a new observation (440). For example, the second neural network 125 can process the point cloud observation and the latent variable θ 120 to generate as output, 2048 data points of a new observation 130. For example, the second neural network 125 that includes four LSTM blocks that can further include an MLP with 64, 128 and 512 hidden neurons with interleaved ReLU. Each LSTM block can generate 512 data points autoregressively generating a total of 2048 data points such that each set of 512 data points can be generated based on the prior set of 512 data points and the latent variable θ. The 2048 data points can then be used to identify the vehicle.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit.

Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, comprising:
obtaining a dataset comprising a plurality of training observations, wherein each training observation is an exchangeable set, the exchangeable set comprising a plurality of data points;
for each training observation:
processing, using a first neural network, the data points of the training observation to generate parameters of a first probability distribution;
sampling, from the first probability distribution, a latent variable based on the first probability distribution;
processing the latent variable using a second neural network to generate a new observation comprising a plurality of data points; and
processing the training observation and the new observation using an energy neural network to generate an estimate of an energy of the training observation and an estimate of an energy of the new observation; and
training the energy neural network to optimize an objective function that measures the difference between the estimate of the energy of the training observation and the estimate of the energy of the new observation.

2. The method of claim 1, further comprising:
training the first neural network to model the data points of the training observation as a stochastic process; and
training the energy neural network to optimize the objective function that minimizes the difference between the distribution of the training observations and the new observations.

3. The method of claim 1, wherein the objective function of the energy neural network is of the form
$$\begin{matrix}max \\ {{w}^{′} , q}_{} ( {θ \vert x}_{1 : n} )\end{matrix} \begin{matrix}min \\ {}_{q} ( {x}_{1 : n} , v \text{\textbar θ} )\end{matrix} \begin{matrix}L ( q ( {\text{θ\textbar} x}_{1 : n} ) , q ( {x}_{1 : n} , v \text{\textbar θ} ) ; {w}^{′} ) \\ \end{matrix}$$
$$wherein$$
$$L ( q ( {\text{θ\textbar} x}_{1 : n} ) , q ( {x}_{1 : n} , v \text{\textbar θ} ) ; {w}^{′} ) := {\hat{𝔼}}_{{x}_{1 : n}} {𝔼}_{q} ( {\text{θ\textbar} x}_{1 : n} ) [ {f}_{{w}^{′}} ( {x}_{1 : n} ; θ ) ] - {\hat{𝔼}}_{{x}_{1 : n}} {𝔼}_{q} ( {\text{θ\textbar} x}_{1 : n} ) [ {𝔼}_{q} ( {x}_{1 : n} , v \text{\textbar θ} ) [ {f}_{{w}^{′}} ( {x}_{1 : n} ; θ ) - \frac{λ}{2} {v}^{T} v ] ] - {\hat{𝔼}}_{{x}_{1 : n}} [ H ( q ( {x}_{1 : n} , v \text{\textbar θ} ) ) - KL ( q ( {\text{θ\textbar} x}_{1 : n} ) \vert \vert p ( θ ) ) ]$$
and wherein x_{1:n} are the training data points, θ is the latent variable, q is the first probability distribution, v is a auxiliary momentum variable and H is a Hamiltonian dynamic embeddings.

4. The method of claim 1, wherein the first probability distribution belongs to an exponential family of distributions.

5. The method of claim 1, wherein each training observation of the dataset comprises a plurality of unordered data points.

6. The method of claim 1, wherein the training observation is a set of points from a point cloud.

7. The method of claim 1, wherein the second neural network is a recurrent neural network that generates the data points in the new observation over a plurality of time steps.

8. The method of claim 1, wherein the first neural network is a convolutional neural network.

9. A system, comprising:
obtaining a dataset comprising a plurality of training observations, wherein each training observation is an exchangeable set, the exchangeable set comprising a plurality of data points;
for each training observation:
processing, using a first neural network, the data points of the training observation to generate parameters of a first probability distribution;
sampling, from the first probability distribution, a latent variable based on the first probability distribution;
processing the latent variable using a second neural network to generate a new observation comprising a plurality of data points; and
processing the training observation and the new observation using an energy neural network to generate an estimate of an energy of the training observation and an estimate of an energy of the new observation; and
training the energy neural network to optimize an objective function that measures the difference between the estimate of the energy of the training observation and the estimate of the energy of the new observation.

10. The system of claim 9, further comprising:
training the first neural network to model the data points of the training observation as a stochastic process; and
training the energy neural network to optimize the objective function that minimizes the difference between the distribution of the training observations and the new observations.

11. The system of claim 9, wherein the objective function of the energy neural network is of the form
$$\begin{matrix}max \\ {{w}^{′} , q}_{} ( {θ \vert x}_{1 : n} )\end{matrix} \begin{matrix}min \\ {}_{q} ( {x}_{1 : n} , v \text{\textbar θ} )\end{matrix} \begin{matrix}L ( q ( {\text{θ\textbar} x}_{1 : n} ) , q ( {x}_{1 : n} , v \text{\textbar θ} ) ; {w}^{′} ) \\ \end{matrix}$$
$$wherein$$
$$L ( q ( {\text{θ\textbar} x}_{1 : n} ) , q ( {x}_{1 : n} , v \text{\textbar θ} ) ; {w}^{′} ) := {\hat{𝔼}}_{{x}_{1 : n}} {𝔼}_{q} ( {\text{θ\textbar} x}_{1 : n} ) [ {f}_{{w}^{′}} ( {x}_{1 : n} ; θ ) ] - {\hat{𝔼}}_{{x}_{1 : n}} {𝔼}_{q} ( {\text{θ\textbar} x}_{1 : n} ) [ {𝔼}_{q} ( {x}_{1 : n} , v \text{\textbar θ} ) [ {f}_{{w}^{′}} ( {x}_{1 : n} ; θ ) - \frac{λ}{2} {v}^{T} v ] ] - {\hat{𝔼}}_{{x}_{1 : n}} [ H ( q ( {x}_{1 : n} , v \text{\textbar θ} ) ) - KL ( q ( {\text{θ\textbar} x}_{1 : n} ) \vert \vert p ( θ ) ) ]$$
and wherein x_{1:n} are the training data points, θ is the latent variable, q is the first probability distribution, v is a auxiliary momentum variable and H is a Hamiltonian dynamic embeddings.

12. The system of claim 9, wherein the first probability distribution belongs to an exponential family of distributions.

13. The system of claim 9, wherein each training observation of the dataset comprises a plurality of unordered data points.

14. The system of claim 9, wherein the training observation is a set of points from a point cloud.

15. The system of claim 9, wherein the second neural network is a recurrent neural network that generates the data points in the new observation over a plurality of time steps.

16. The system of claim 9, wherein the first neural network is a convolutional neural network.

17. A non-transitory computer readable medium storing instructions that, when executed by one or more data processing apparatus, cause the one or more data processing apparatus to perform operations comprising:
obtaining a dataset comprising a plurality of training observations, wherein each training observation is an exchangeable set, the exchangeable set comprising a plurality of data points;
for each training observation:
processing, using a first neural network, the data points of the training observation to generate parameters of a first probability distribution;
sampling, from the first probability distribution, a latent variable based on the first probability distribution;
processing the latent variable using a second neural network to generate a new observation comprising a plurality of data points; and
processing the training observation and the new observation using an energy neural network to generate an estimate of an energy of the training observation and an estimate of an energy of the new observation; and
training the energy neural network to optimize an objective function that measures the difference between the estimate of the energy of the training observation and the estimate of the energy of the new observation.

18. The non-transitory computer readable medium of claim 17, further comprising:
training the first neural network to model the data points of the training observation as a stochastic process; and
training the energy neural network to optimize the objective function that minimizes the difference between the distribution of the training observations and the new observations.

19. The non-transitory computer readable medium of claim 17, wherein the objective function of the energy neural network is of the form
$$\begin{matrix}max \\ {{w}^{′} , q}_{} ( {θ \vert x}_{1 : n} )\end{matrix} \begin{matrix}min \\ {}_{q} ( {x}_{1 : n} , v \text{\textbar θ} )\end{matrix} \begin{matrix}L ( q ( {\text{θ\textbar} x}_{1 : n} ) , q ( {x}_{1 : n} , v \text{\textbar θ} ) ; {w}^{′} ) \\ \end{matrix}$$
$$wherein$$
$$L ( q ( {\text{θ\textbar} x}_{1 : n} ) , q ( {x}_{1 : n} , v \text{\textbar θ} ) ; {w}^{′} ) := {\hat{𝔼}}_{{x}_{1 : n}} {𝔼}_{q} ( {\text{θ\textbar} x}_{1 : n} ) [ {f}_{{w}^{′}} ( {x}_{1 : n} ; θ ) ] - {\hat{𝔼}}_{{x}_{1 : n}} {𝔼}_{q} ( {\text{θ\textbar} x}_{1 : n} ) [ {𝔼}_{q} ( {x}_{1 : n} , v \text{\textbar θ} ) [ {f}_{{w}^{′}} ( {x}_{1 : n} ; θ ) - \frac{λ}{2} {v}^{T} v ] ] - {\hat{𝔼}}_{{x}_{1 : n}} [ H ( q ( {x}_{1 : n} , v \text{\textbar θ} ) ) - KL ( q ( {\text{θ\textbar} x}_{1 : n} ) \vert \vert p ( θ ) ) ]$$
and wherein x_{1:n} are the training data points, θ is the latent variable, q is the first probability distribution, v is a auxiliary momentum variable and H is a Hamiltonian dynamic embeddings.

20. The non-transitory computer readable medium of claim 17, wherein the first probability distribution belongs to an exponential family of distributions.
